(19) United States
(12) Patent Application Publication
(10) Pub. No.: US 2025/0329816 A1
(43) Pub. Date: Oct. 23, 2025

(54) BATTERY COOLING

(71) Applicant: GM GLOBAL TECHNOLOGY OPERATIONS LLC, Detroit, MI (US)

(72) Inventors: William Yu Chen, Troy, MI (US); Xianfeng Yan, Clawson, MI (US); Jung Woo Seo, Troy, MI (US)

(73) Assignee: GM GLOBAL TECHNOLOGY OPERATIONS LLC, Detroit, MI (US)

(21) Appl. No.: 18/643,231

(22) Filed: Apr. 23, 2024

(51) Int. Cl. H01M 10/6556; H01M 10/613; H01M 10/625; H01M 10/653; H01M 10/6554; H01M 10/6567; H01M 50/244; H01M 50/342

(52) U.S. Cl. CPC H01M 10/6556; H01M 10/613; H01M 10/625; H01M 10/653; H01M 10/6554; H01M 10/6567; H01M 50/244; H01M 50/3425

(57) ABSTRACT

A battery cooling system, a method for cooling a battery cell, and vehicle provided with a battery cooling system are provided. A battery cooling system includes a rigid plate having a surface formed with channels; a flexible film contacting the surface and enclosing the channels; battery cells; and a coolant fluid located in the channels, wherein pressure from the coolant fluid pushes the flexible film into contact with the battery cells.

### INTRODUCTION

The disclosure relates to motor vehicle thermal management systems, and more specifically to systems and methods for cooling batteries.

Electrochemical battery packs are used in a host of battery electric systems. Aboard an electric vehicle (EV) in particular, a high-energy propulsion battery pack is arranged on a direct current (DC) voltage bus, with the propulsion battery pack having an application-suitable number of cylindrical, prismatic, or pouch-style electrochemical battery cells. The DC voltage bus ultimately powers one or more electric traction motors and associated power electronic components during battery discharging modes. The same DC voltage bus conducts a charging current to constituent battery cells of the battery pack during battery charging modes.

Propulsion battery packs for use with electric vehicles and other battery electric systems typically utilize a lithium-based or nickel-based battery chemistry. In lithium-ion battery cells, for instance, the movement of electrons and lithium ions produces electricity for use in powering the above-noted electric traction motor(s). Charging and discharging of the battery cells is accompanied by a discharge of heat. The generated heat in turn must be dissipated from the battery cells, e.g., via circulation of battery coolant, cooling plates, or cooling fins. Under rare conditions, battery cell damage, age, or degradation could lead to the generation of heat in a battery cell or battery pack at a rate exceeding an existing cooling capability. Such a condition is referred to both herein and in the art as thermal runaway.

Accordingly, there is a need for systems and methods for cooling EV batteries which efficiently dissipate thermal energy away from EV batteries, while reducing hardware cost and complexity, improving reliability, and offering improved safety and redundancy, and/or reduced range anxiety for EV operators. Furthermore, other desirable features and characteristics of the present disclosure will become apparent from the subsequent detailed description and the appended claims, taken in conjunction with the accompanying drawings and the foregoing technical field and background.

### SUMMARY

In one embodiment, a battery cooling system includes a rigid plate having a surface formed with channels; a flexible film contacting the surface and enclosing the channels; battery cells; and a coolant fluid located in the channels, wherein pressure from the coolant fluid pushes the flexible film into contact with the battery cells.

In certain embodiments of the battery cooling system, the flexible film includes windows, and the battery cooling system further includes adhesive located in the windows and interconnecting the battery cells and the surface of the rigid plate.

In certain embodiments, the battery cooling system further includes mechanical fasteners fastening the battery cells to the rigid plate.

In certain embodiments, the battery cooling system, further includes a skid plate mounted to the rigid plate.

In certain embodiments of the battery cooling system, the flexible film is a composite laminate film including layers selected from polypropylene, metal, nylon, and polyethylene.

In certain embodiments of the battery cooling system, each battery cell is formed with a cell vent; the surface of the rigid plate is formed with a conduit; the battery cooling system further includes an insulation strip enclosing the conduit; the insulation strip includes perforated regions; and each perforated region is aligned with a respective cell vent and is configured to open when vent gas is expelled from the respective cell vent.

In certain embodiments of the battery cooling system, the insulation strip is mica.

In another embodiment, a method for cooling a battery cell includes enclosing channels between a flexible film and a rigid plate; mounting the battery cell to the rigid plate, wherein the flexible film is located between the battery cell and the rigid plate; flowing a coolant fluid through the channels and forcing the flexible film into contact with the battery cell; and transferring heat from the battery cell to the coolant fluid through the flexible film.

In certain embodiments, the method further includes hot welding the flexible film to the rigid plate.

In certain embodiments of the method, the flexible film includes windows, and mounting the battery cell to the rigid plate includes locating adhesive in the windows and interconnecting the battery cell and the rigid plate with the adhesive.

In certain embodiments of the method, mounting the battery cell to the rigid plate includes fastening the battery cell to the rigid plate with mechanical fasteners.

In certain embodiments, the method, further including mounting the rigid plate to a skid plate.

In certain embodiments of the method, the flexible film is a composite laminate film including layers selected from polypropylene, metal, nylon, and polyethylene.

In certain embodiments of the method, the battery cell is formed with a cell vent; the rigid plate is formed with a conduit; the method further includes enclosing the conduit with an insulation strip; the insulation strip includes a perforated region; and the perforated region is aligned with the cell vent and is configured to open when vent gas is expelled from the cell vent.

In certain embodiments of the method, the insulation strip is mica.

In another embodiment, a vehicle includes an electric motor; battery cells interconnected to the electric motor; a battery cooling system including: a first side and an opposite second side, wherein the first side is rigid and has a surface formed with channels, and wherein the second side is flexible and encloses the channels; and a coolant fluid located in the channels, wherein pressure from the coolant fluid pushes the second side into contact with the battery cells.

In certain embodiments of the vehicle, the second side includes windows, and wherein the battery cooling system further includes adhesive located in the windows and interconnecting the battery cells and the surface of the first side.

In certain embodiments of the vehicle, the second side is a composite laminate film including layers selected from polypropylene, metal, nylon, and polyethylene.

In certain embodiments of the vehicle, each battery cell is formed with a cell vent; the surface of the first side is formed with a conduit; the battery cooling system further includes an insulation strip enclosing the conduit; the insulation strip includes perforated regions; and each perforated region is aligned with a respective cell vent and is configured to open when vent gas is expelled from the respective cell vent.

In certain embodiments of the vehicle, the first side is a battery tray or a battery cover.

### DESCRIPTION OF THE DRAWINGS

The present disclosure will hereinafter be described in conjunction with the following drawing figures, wherein like numerals denote like elements, and wherein:

FIG. 1 is a schematic environmental view of a motor vehicle having an electric propulsion system, such as a hybrid electric vehicle or battery electric vehicle.

FIG. 2 is a schematic system diagram depicting a thermal management system for a motor vehicle, such as that shown in FIG. 1.

FIG. 3 is a side view schematic of a battery cooling system for the vehicle of FIG. 1 in accordance with exemplary embodiments.

FIG. 4 is a top view of a flexible film formed with windows for use in the battery cooling system of FIG. 3 in accordance with exemplary embodiments.

FIG. 5 is a side view schematic of a battery cooling system for the vehicle of FIG. 1 in accordance with exemplary embodiments.

FIG. 6 is a side view schematic of a battery cooling system for the vehicle of FIG. 1 in accordance with exemplary embodiments.

FIG. 7 is a side view schematic of a battery cooling system for the vehicle of FIG. 1 in accordance with exemplary embodiments.

FIG. 8 is a side view schematic of a battery cooling system for the vehicle of FIG. 1 in accordance with exemplary embodiments.

FIG. 9 is a flow chart illustrating a method for cooling in accordance with certain embodiments.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description. As used herein, the term “module” refers to any hardware, software, firmware, electronic control unit or component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may conduct a variety of functions under the control of one or more microprocessors or other control devices. In addition, those skilled in the art will appreciate that embodiments of the present disclosure may be practiced in conjunction with any number of automated driving systems including cruise control systems, automated driver assistance systems and autonomous driving systems, and that the vehicle system described herein is merely one example embodiment of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

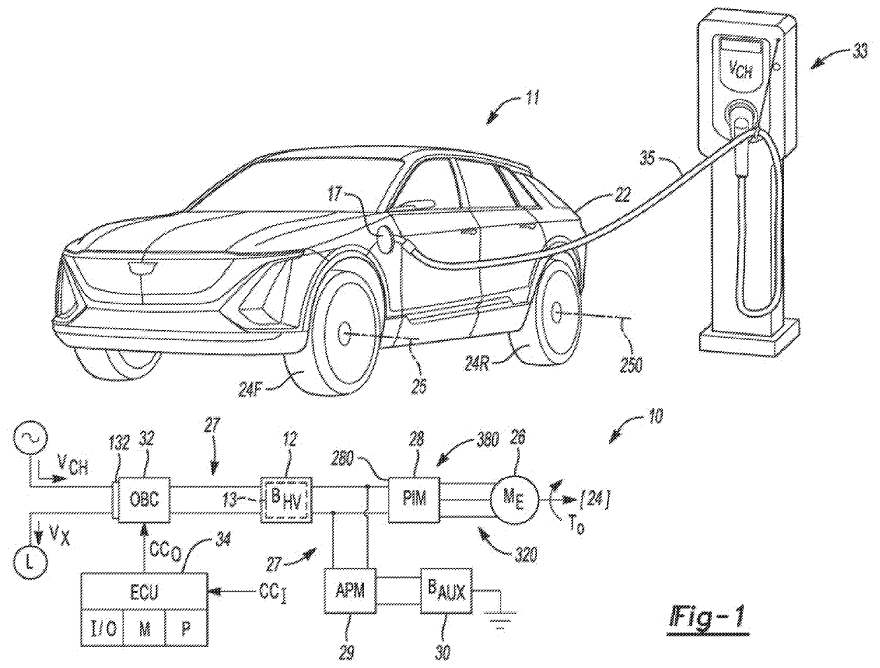

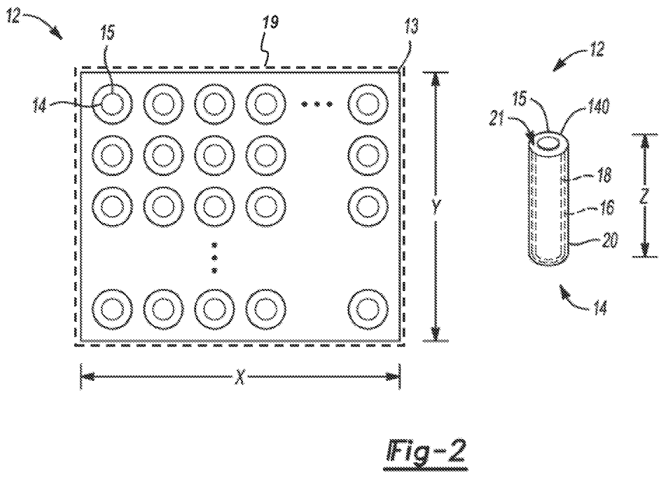

Referring to the drawings, wherein like reference numbers refer to like features throughout the several views, FIG. 1 depicts an electrified powertrain system 10 having a high-voltage battery pack (BHV) or module 12. In a non-limiting example, the battery pack 12 may be embodied as a high-capacity battery having a voltage capability of about 400-800 volts or more, with the actual voltage capability of the battery pack 12 provided based on a desired operating range, gross weight, and power rating of a load connected to the battery pack 12. In a possible construction, the battery pack 12 may be a propulsion battery pack generally composed of an array of lithium-ion or lithium-ion polymer rechargeable electrochemical battery cells, exemplified herein as a cylindrical battery cell 14 as best shown in FIG. 2. The present teachings may also be applied to prismatic battery cells, and possibly to pouch-style battery cells in possible configurations, and thus the cylindrical battery cell 14 is exemplary without being limiting.

Referring briefly to FIG. 2, the battery pack 12 of FIG. 1 includes a battery tray 13 and a battery cover 19 positioned with respect to a plurality of the cylindrical battery cells 14. For example, the battery tray 13 may form a side and the battery cover 19 may form an opposite side, and the battery cells 14 may be located between the sides 13 and 19.

Within the scope of the present disclosure, each respective one of the battery cells 14 includes a sacrificial vent cap 15 operable for releasing hot gasses from the battery cell 14 to a vent passage during a thermal runaway condition. Each battery cell 14 includes an outer can or casing 20 defining a cell cavity 21 therein and having an end surface 140.

Although internal details of the battery cells 14 are omitted for illustrative simplicity, those skilled in the art will appreciate that the battery cells 14 contain within the cell cavity 21 an electrolyte material, working electrodes in the form of a cathode 16 and an anode 18, and a permeable separator (not shown), which are collectively enclosed inside an electrically-insulated can or casing 20. Grouped battery cells 14 may be connected in series or parallel through use of an electrical interconnect board and related buses, sensing hardware, and power electronics (not shown but well understood in the art). An application-specific number of the battery cells 14 of FIG. 2 may be arranged relative to the battery tray 13 in columns and rows as shown. In a nominal “xyz” Cartesian reference frame, for instance, the battery tray 13 when viewed from above or below may have a length (x-dimension) and a width (y-direction), with a height (z-dimension) extending in an orthogonal direction away from the battery tray 13.

Referring again to FIG. 1, in a representative use case the electrified powertrain system 10 may be used as part of a motor vehicle 11 or another mobile system. As shown, the motor vehicle 11 may be embodied as a battery electric vehicle, with the present teachings also being extendable to plug-in hybrid electric vehicles. Alternatively, the electrified powertrain system 10 may be used as part of another mobile system such as but not limited to a rail vehicle, aircraft, marine vessel, robot, farm equipment, etc. Likewise, the electrified powertrain system 10 may be stationary, such as in the case of a powerplant, hoist, drive belt, or conveyor system. Therefore, the electrified powertrain system 10 in the representative vehicular embodiment of FIG. 1 is intended to be illustrative of the present teachings and not limiting thereof.

The vehicle 11 shown in FIG. 1 includes a vehicle body 22 and road wheels 24F and 24R, with “F” and “R” indicating the respective front and rear positions. The road wheels 24F and 24R rotate about respective axes 25 and 250, with the road wheels 24F, the road wheels 24R, or both being powered by output torque (arrow Tₒ) from a rotary electric machine (ME) 26 of the electrified powertrain system 10 as indicated by arrow 24. The road wheels 24F and 24R thus represent a mechanical load in this embodiment, with other possible mechanical loads being possible in different host systems. To that end, the electrified powertrain system 10 includes a power inverter module (PIM) 28 and the high-voltage battery pack 12, e.g., a multi-cell lithium-ion propulsion battery or a battery having another application-suitable chemistry, both of which are arranged on a high-voltage DC bus 27. As appreciated in the art, the PIM 28 includes a DC side 280 and an alternating current (AC) side 380, with the latter being connected to individual phase windings (not shown) of the rotary electric machine 26 when the rotary electric machine 26 is configured as a polyphase rotary electric machine in the form of a propulsion or traction motor as shown.

The battery pack 12 of FIG. 1 in turn is connected to the DC side 280 of the PIM 28, such that a battery voltage from the battery pack 12 is provided to the PIM 28 during propulsion modes of the motor vehicle 11. The PIM 28, or more precisely a set of semiconductor switches (not shown) residing therein, are controlled via pulse width modulation, pulse density modulation, or other suitable switching control techniques to invert a DC input voltage on the DC bus 27 into an AC output voltage suitable for energizing a high-voltage AC bus 320. High-speed switching of the resident semiconductor switches of the PIM 28 thus ultimately energizes the rotary electric machine 26 to thereby cause the rotary electric machine 26 to deliver the output torque (arrow Tₒ) as a motor drive torque to one or more of the road wheels 24F and/or 24R in the illustrated embodiment of FIG. 1, or to another coupled mechanical load in other implementations.

Electrical components of the electrified powertrain system 10 may also include an accessory power module (APM) 29 and an auxiliary battery (B_{AUX}) 30. The APM 29 is configured as a DC-DC converter that is connected to the DC bus 27, as appreciated in the art. In operation, the APM 29 is capable, via internal switching and voltage transformation, of reducing a voltage level on the DC bus 27 to a lower level suitable for charging the auxiliary battery 30 and/or supplying low-voltage power to one or more accessories (not shown) such as lights, displays, etc. Thus, “high-voltage” refers to voltage levels well in excess of typical 12-15V low/auxiliary voltage levels, with 400V or more being an exemplary high-voltage level in some embodiments of the battery pack 12.

In some configurations, the electrified powertrain system 10 of FIG. 1 may include an on-board charger (OBC) 32 that is selectively connectable to an offboard charging station 33 via an input/output (I/O) block 132 during a charging mode during which the battery pack 12 is recharged by an AC charging voltage (VCH) from the offboard charging station 33. The I/O block 132 is connectable to a charging port 17 on the vehicle body 22. For instance, a charging cable 35 may be connected to the charging port 17, e.g., via an SAE J1772 connection. The electrified powertrain system 10 may also be configured to selectively receive a DC charging voltage in one or more embodiments as appreciated in the art, in which case the OBC 32 would be selectively bypassed using circuitry (not shown) that is not otherwise germane to the present disclosure. The OBC 32 could operate in different modes, including a charging mode during which the OBC 32 receives the AC charging voltage (VCH) from the offboard charging station 33 to recharge the battery pack 12, and a discharging mode, represented by arrow VX, during which the OBC 32 offloads power from the battery pack 12 to an external AC electrical load (L). In this manner, the OBC 32 may embody a bidirectional charger.

Still referring to FIG. 1, the electrified powertrain system 10 may also include an electronic control unit (ECU) 34. The ECU 34 is operable for regulating ongoing operation of the electrified powertrain system 10 via transmission of electronic control signals (arrow CCO). The ECU 34 does so in response to electronic input signals (arrow CCI). Such input signals (arrow CCI) may be actively communicated or passively detected in different embodiments, such that the ECU 34 is operable for determining a particular mode of operation. In response, the ECU 34 controls operation of the electrified powertrain system 10.

To that end, the ECU 34 may be equipped with one or more processors (P), e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock to provide the described functionality. The ECU 34 also includes an associated computer-readable storage medium, i.e., memory (M) inclusive of read only, programmable read only, random access, a hard drive, etc., whether resident, remote or a combination of both. Control routines are executed by the processor to monitor relevant inputs from sensing devices and other networked control modules (not shown), and to execute control and diagnostic routines to govern operation of the electrified powertrain system 10.

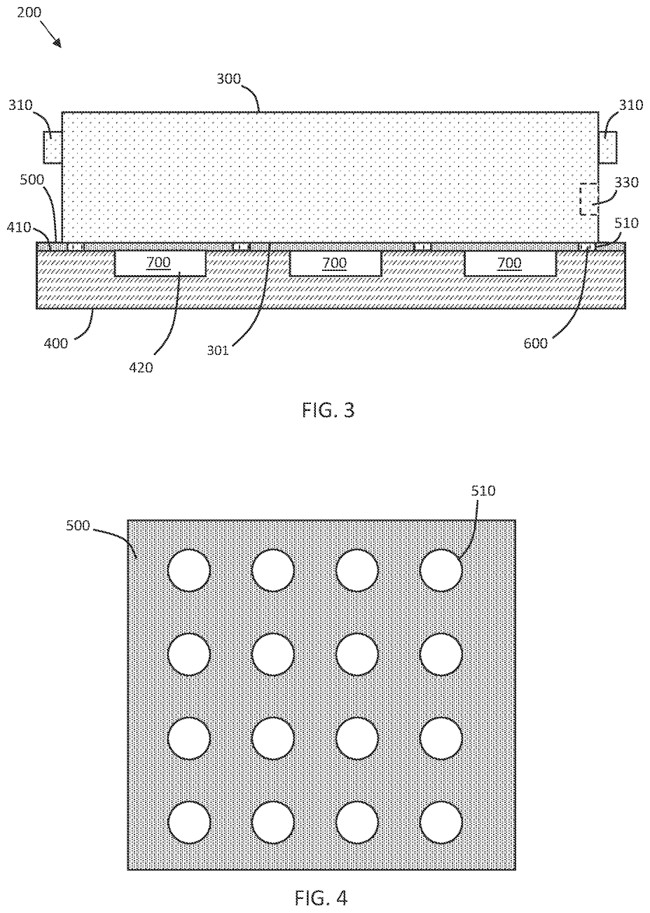

Referring now to FIG. 3, an exemplary battery cooling system 200 is illustrated. As shown, the battery cooling system 200 may include a heat source 300. In certain embodiments, the heat source 300 is a battery module or pack, such as battery pack 12, or a battery cell, such as battery cell 14. A battery cell heat source 300 may have terminal 310 and a vent 330.

The battery cooling system 200 may further include a plate 400. In certain embodiments, the plate 400 may be a battery tray, such as battery tray 13. For example, the plate 400 may mechanically support the heat source 300 and a battery cover 19 may be fixed to the plate 400 to enclose the battery cell heat source 300. In other embodiments, the plate 400 may be a battery cover, such as battery cover 19. For example, a battery tray 13 may support the heat source 300, and the plate 400 may be positioned over or on a side of the heat source 300. While a single plate 400 is illustrated, it is also contemplated that a first plate 400 may be used to cool a first side of the heat source 300 and a second plate 400 may be used to cool a second side of the heat source 300. In certain embodiments, one of the first plate and the second plate may be a battery tray 13 to which a bottom side of the heat source 300 is mounted. Alternatively, the bottom side of the heat source may be supported by a battery tray 13, and first and second plates 400 may be used to cool non-bottom sides of the heat source 300.

The plate 400 of FIG. 3 may be considered to be a manifold. In certain embodiments, the plate 400 is rigid, i.e., non-flexible. The plate 400 may be thermally conductive. In certain embodiments, the plate 400 is an injection-molded plastic or composite material. In other embodiments, the plate 400 is cast metal, such as cast aluminum. As shown, the plate 400 has a surface 410 that is formed with open channels or recesses 420.

As shown, the battery cooling system 200 includes a flexible film 500. An exemplary flexible film 500 is a composite laminate film. For example, the flexible film 500 may include layers of polypropylene, metal such as aluminum, nylon, and/or polyethylene.

In certain embodiments, the flexible film 500 has a thickness of from 100 to 500 micrometers (μm). For example, the flexible film 500 may have a thickness of at least 100 μm, such as at least 125, at least 150, at least 175, at least 200, at least 250 or at least 300 μm. In certain embodiments, the flexible film may have a thickness of no more than 500 μm, such as no more than 450, no more than 400, no more than 300, no more than 250, no more than 200, no more than 180, no more than 170, no more than 160, or no more than 150 μm. Certain layers within the flexible film 500 may have a thickness of at least 5 μm, such as at least 10, at least 15, at least 20, at least 25, at least 30, at least 35, at least 40, at least 45, or at least 50 μm. Such layers within the flexible film 500 may have a thickness of at most 60 μm, such as at most 55, at most 50, at most 45, at most 40, at most 35, at most 30, at most 25, at most 20, at most 15, or at most 10 μm.

In certain embodiments, the flexible film 500 contacts the surface 410 of the plate 400 and encloses the channels 420. The flexible film 500 may be bonded to the surface 410 of the plate 400. For example, the flexible film 500 may be hot welded to the surface 410 of the plate 400. A bond formed by hot welding seals the flexible film 500 and the plate 400. During the hot welding process, the layer of the flexible film 500 that contacts the plate 400, such as a polypropylene layer, is locally melted and welded to the plate 400, creating a rigid joint between flexible film 500 and the plate 400. No fluid is able to pass through the joint between flexible film 500 and the plate 400. In certain embodiments, the bonded connection between the flexible film 500 and the plate 400 may be coextensive with the surface 410 and may be interrupted by the channels 420 such that the portion of the flexible film 500 lying over the channels 420 is not connected to any rigid structure and may move upward and downward due to forces of pressure or gravity.

As shown in FIG. 3, the battery cooling system 200 may further include adhesive 600 located between the plate 400 and the heat source 300. In the embodiment of FIG. 3, the flexible film 500 is formed with windows 510. FIG. 4 provides a top view of an exemplary flexible film 500, illustrating that the flexible film 500 may include windows 510 that may be spaced from one another to provide for direct connection of the plate 400 to the heat source 300, such as to a battery module or to a plurality of battery cells.

As shown in FIG. 3, adhesive 600 may be located in the windows 510 of the flexible film 500 and directly connect the heat source 300 to the plate 400.

In other embodiments, the flexible film 500 may be formed without windows 510 such that the upper surface 410 of the plate 400 is completely covered by the flexible film 500. In such embodiments, the adhesive 600 may be located on the flexible film 500 and may bond the heat source 300 directly to the flexible film 500 and indirectly to the plate 400.

In FIG. 3, the battery cooling system 200 further includes a coolant fluid 700. The coolant fluid 700 is flowed through the channels 420 enclosed by the flexible film 500. When pumped through, or held within, the channels 420, the coolant fluid 700 exerts a pressure on the flexible film 500, pushing the flexible film 500 outward from the channels 420. As a result, good thermal contact between the flexible film 500 and the heat source 300 is ensured. Thus, heat transfer from the heat source 300 to the coolant fluid 700 through the flexible film 500 is optimized.

In FIG. 3, the rigid plate 400 is located under the battery cell heat source 300. For example, a bottom surface 301 of the heat source 300 may be supported by the rigid plate 400. Thus, the rigid plate 400 may serve as a supporting tray 13 for the heat source 300. In such embodiments, the rigid plate 400 cools the bottom surface 301.

Referring now to FIG. 5, an embodiment in which the rigid plate 400 is located over the battery cell heat source 300. For example, a bottom surface 301 of the heat source 300 may be supported by a battery tray 13 while the rigid plate 400 cools a non-bottom surface, such a top surface. In such embodiments, the rigid plate 400 may be or may form part of a cover 19, or may be located between the heat source 300 and the cover 19. While the orientation is different, the components of the battery cooling system 200 of FIG. 5 are otherwise identical to the battery cooling system 200 of FIG. 3.

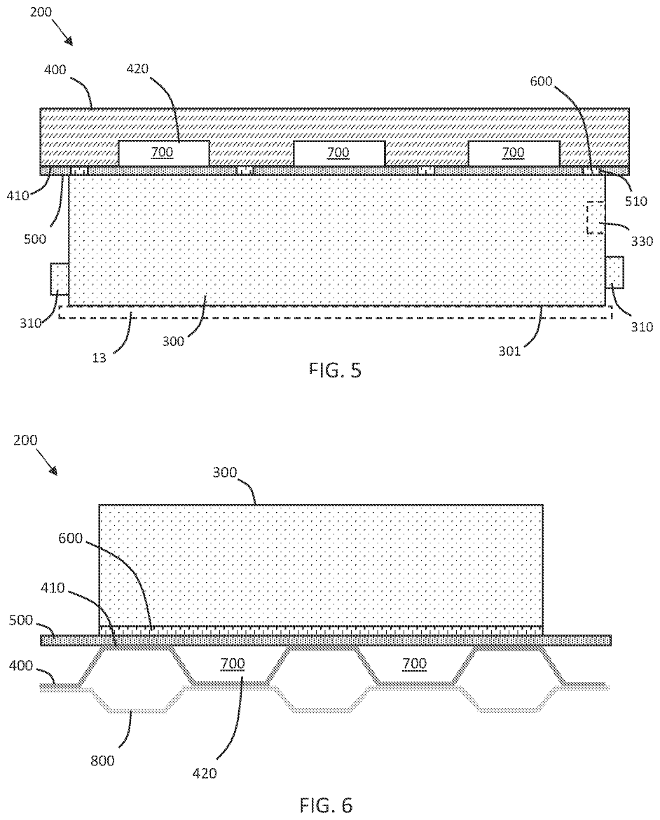

FIG. 6 illustrates another embodiment of the battery cooling system 200. In FIG. 6, the plate 400 is formed as a stamped sheet, such as a stamped aluminum sheet, with an upper surface 410 and channels 420. To provide structural support, a skid plate 800 is mounted to the plate 400, as shown.

In the illustrated embodiment of FIG. 6, the flexible film 500 is formed without windows 510 such that the upper surface 410 of the plate 400 is completely covered by the flexible film 500. As shown, adhesive 600 is located on the flexible film 500 and bonds the heat source 300 directly to the flexible film 500 and indirectly to the plate 400. In other embodiments, the flexible film 500 is formed with windows 510 and the adhesive 600 may be located in the windows 510 of the flexible film 500 to directly connect the heat source 300 to the plate 400.

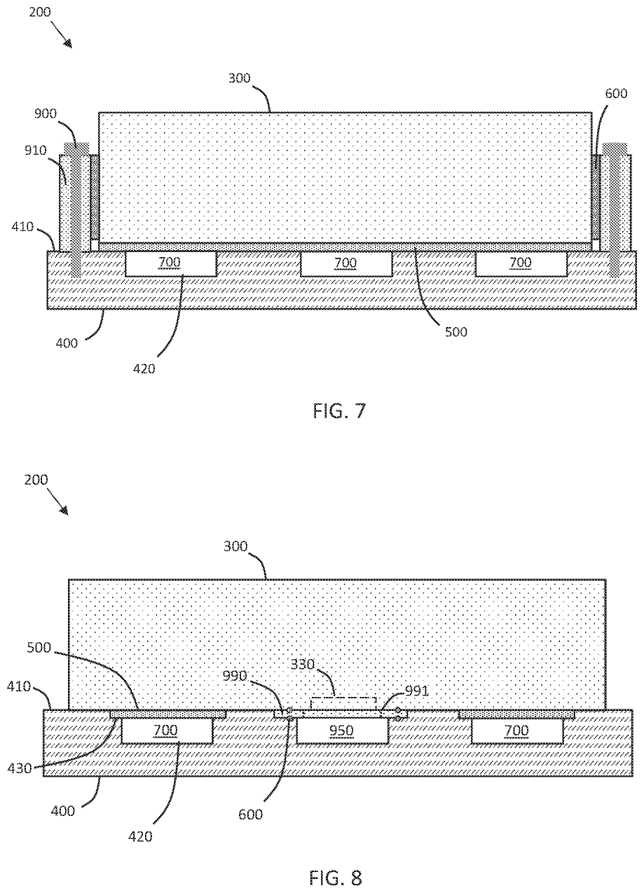

FIG. 7 illustrates another embodiment of the battery cooling system 200. In FIG. 7, the plate 400 is connected to the heat source 300 by mechanical fasteners 900. For example, end plates 910 formed with bores are connected to the heat source 300, such as by adhesive 600. Fasteners 900, such as bolts, pass through the bores of the end plates 910 and extend into the plate 400, thus securing the heat source 300 to the plate 400.

In FIG. 8, another embodiment of the battery cooling system 200 is illustrated. In FIG. 8, the heat source 300 may be a battery cell having a cell vent 330 on the surface mounted to the plate 400. The heat source 300 may be a battery pack including cells having cell vents 330 on the surface mounted to the plate 400. The cell vents 330 may be aligned.

In FIG. 8, the flexible film 500 may not cover the entire surface 410 of the plate 400. Rather, portions or segments of the flexible film 500 may be provided in regions covering the channels 420. The portions of flexible film 500 may be bonded to a ledge surface 430 as shown or to the surface 410 of the plate 400.

In FIG. 8, the plate 400 is further formed with a vent conduit 950 aligned with the cell vent or vents 330. The battery cooling system 200 further includes an insulation strip 990 covering the vent conduit 950. The insulation strip 990 is formed with a perforation 991 aligned with each individual cell vent 330. In certain embodiments, the insulation strip 990 is formed from mica. As shown, the insulation strip 990 may be bonded to the heat source 300 and plate 400 by adhesive 600.

In case of an overheating situation, such as thermal runaway, vent gas may be emitted through the cell vent 330. The pressure of the emitted vent gas causes the perforation 991 to open, allowing the vent gas to flow into the vent conduit 950. The plate 400, cooled by the coolant fluid 700, may cool the vent conduit 950 and vent gas therein. The insulation strip 990 over adjacent cell vents 330 remains un-opened and may protect the adjacent cells from the heated vent gas.

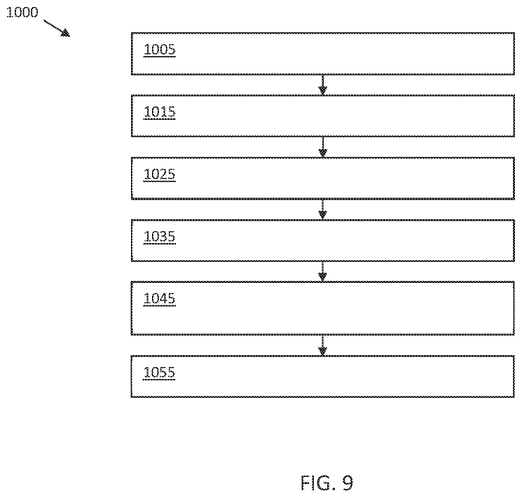

FIG. 9 illustrates a method 1000 for cooling. Method 1000 includes, at operation 1005, enclosing channels 420 between a flexible film 500 and a rigid plate 400. Operation 1005 may include hot welding the flexible film to the plate. Certain embodiments may include mounting the plate to an additional skid plate.

Method 1000 may include enclosing a vent conduit 950 with an insulation strip 990 at operation 1015.

Method 1000 includes, at operation 1025, mounting a battery cell as the heat source 300 to the plate 400, wherein the flexible film 500 is located between the battery cell 300 and the plate 400. Operation 1025 may include adhering the battery cell 300 directly to the plate 400, indirectly to the plate 400 through the film 500, or mechanically fastening the battery cell 300 to the plate 400.

Method 1000 includes, at operation 1035, flowing a coolant fluid 700 through the channels 420 and forcing the flexible film 500 into contact with the battery cell 300.

Method 1000 includes, at operation 1045, transferring heat from the battery cell 300 to the coolant fluid 700 through the flexible film.

Method 1000 includes, at operation 1055, opening a perforated region of the insulation strip when vent gas is expelled from the cell vent and flowing the vent gas through the vent conduit.

As described herein, a plate has coolant channel passages that are sealed to a composite laminate film. This composite laminate film will inflate under coolant pressure and contact the cells, providing cooling function to the cells without the need for a thermal interface material. This design obviates the need for thermal interface material for cooling while still maintaining a rigid plate for structural purposes.

As used herein, a “flexible” film is defined as a film that can undergo repeated flexing with a bend radius less than 200 mm, 100 mm, 50 mm, 20 mm, 10 mm, 5 mm, 2 mm, 1 mm, 0.5 mm, or 0.1 mm. A flexible film is non-rigid and will flex under the pressure exerted by the coolant fluid 700 introduced to the battery cooling system 200. On the other hand, a “rigid” structure does not flex under the pressure exerted by a coolant fluid 700 introduced to the battery cooling system 200.

When no positive fluid pressure is exerted on the flexible film 500, the flexible film 500 may sag or otherwise fall out of contact with the heat source 300. When positive fluid pressure is exerted on the flexible film 500, the flexible film 500 is pushed into full contact with, and held against, the heat source 300. In certain embodiments, the flexible film 500 does not stretch or expand under the fluid pressure exerted in the battery cooling system 200. Rather, the flexible film 500 has a constant area whether or not a positive fluid pressure is exerted. In certain embodiments, the flexible film 500 may stretch under the fluid pressure exerted in the battery cooling system 200.

Embodiments herein provide a cooling system including a rigid plate and a flexible top layer. In embodiments herein, sealing of the composite laminate flexible top layer is performed via hot welding to the dissimilar material of the plate. In certain embodiments, thermal interface material is not needed or utilized. In certain embodiments, vent gas during thermal runaway is cooled via the plate or manifold that shares thermal contact with coolant channels. In certain embodiments, the battery cooling system integrates the battery cell or module with the cold plate via fasteners or adhesives that allow for the battery cells or module to be rigidly attached directly to the plate. In certain embodiments, a perforated mica strip or sheet having a perforated blow out vent aligned with a vent gas manifold passageway allows for venting vent gas during thermal runaway.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A battery cooling system comprising:
a rigid plate having a surface formed with channels;
a flexible film contacting the surface and enclosing the channels;
battery cells; and
a coolant fluid located in the channels, wherein pressure from the coolant fluid pushes the flexible film into contact with the battery cells.

2. The battery cooling system of claim 1, wherein the flexible film includes windows, and wherein the battery cooling system further comprises adhesive located in the windows and interconnecting the battery cells and the surface of the rigid plate.

3. The battery cooling system of claim 1, further comprising mechanical fasteners fastening the battery cells to the rigid plate.

4. The battery cooling system of claim 1, further comprising a skid plate mounted to the rigid plate.

5. The battery cooling system of claim 1, wherein the flexible film is a composite laminate film comprising layers selected from polypropylene, metal, nylon, and polyethylene.

6. The battery cooling system of claim 1, wherein:
each battery cell is formed with a cell vent;
the surface of the rigid plate is formed with a conduit;
the battery cooling system further comprises an insulation strip enclosing the conduit;
the insulation strip includes perforated regions; and
each perforated region is aligned with a respective cell vent and is configured to open when vent gas is expelled from the respective cell vent.

7. The battery cooling system of claim 6, wherein the insulation strip is mica.

8. A method for cooling a battery cell, the method comprising:
enclosing channels between a flexible film and a rigid plate;
mounting the battery cell to the rigid plate, wherein the flexible film is located between the battery cell and the rigid plate;
flowing a coolant fluid through the channels and forcing the flexible film into contact with the battery cell; and
transferring heat from the battery cell to the coolant fluid through the flexible film.

9. The method of claim 8, further comprising hot welding the flexible film to the rigid plate.

10. The method of claim 8, wherein the flexible film includes windows, and wherein mounting the battery cell to the rigid plate comprises locating adhesive in the windows and interconnecting the battery cell and the rigid plate with the adhesive.

11. The method of claim 8, wherein mounting the battery cell to the rigid plate comprises fastening the battery cell to the rigid plate with mechanical fasteners.

12. The method of claim 8, further comprising mounting the rigid plate to a skid plate.

13. The method of claim 8, wherein the flexible film is a composite laminate film comprising layers selected from polypropylene, metal, nylon, and polyethylene.

14. The method of claim 8, wherein:
the battery cell is formed with a cell vent;
the rigid plate is formed with a conduit;
the method further comprises enclosing the conduit with an insulation strip;
the insulation strip includes a perforated region; and
the perforated region is aligned with the cell vent and is configured to open when vent gas is expelled from the cell vent.

15. The method of claim 14, wherein the insulation strip is mica.

16. A vehicle comprising:
an electric motor;
battery cells interconnected to the electric motor; and
a battery cooling system comprising:
a first side and an opposite second side, wherein the first side is rigid and has a surface formed with channels, and wherein the second side is flexible and encloses the channels; and
a coolant fluid located in the channels, wherein pressure from the coolant fluid pushes the second side into contact with the battery cells.

17. The vehicle of claim 16, wherein the second side includes windows, and wherein the battery cooling system further comprises adhesive located in the windows and interconnecting the battery cells and the surface of the first side.

18. The vehicle of claim 16, wherein the second side is a composite laminate film comprising layers selected from polypropylene, metal, nylon, and polyethylene.

19. The vehicle of claim 16, wherein:
each battery cell is formed with a cell vent;
the surface of the first side is formed with a conduit;
the battery cooling system further comprises an insulation strip enclosing the conduit;
the insulation strip includes perforated regions; and
each perforated region is aligned with a respective cell vent and is configured to open when vent gas is expelled from the respective cell vent.

20. The vehicle of claim 16, wherein the first side is a battery tray or a battery cover.
